(19) United States
(12) Patent Application Publication
(10) Pub. No.: US 2012/0080290 A1
(43) Pub. Date: Apr. 5, 2012

(54) Conveyor, Belt, and Module Having Multi-Directional Wheels

(75) Inventor: Matthew L. Fourney, Laurel, MD (US)

(73) Assignee: LAITRAM, L.L.C., Harahan, LA (US)

(21) Appl. No.: 12/894,396

(22) Filed: Sep. 30, 2010

(51) Int. Cl. B65G 17/24

(52) U.S. Cl. 198/779

(57) ABSTRACT

A belt conveyor for diverting articles on actuated multi-directional wheels in a conveyor belt. The conveyor belt has article-supporting multi-directional wheels rotatably mounted in cavities in the belt. The wheels are arranged to rotate on axes oblique to the direction of belt travel. A bearing surface underlies the belt along a carryway. As the belt advances along the carryway, the rollers on the periphery of the wheel ride on the bearing surface and cause the wheel to rotate on its oblique axis. Articles conveyed on the belt atop the wheels are diverted by the rotating wheels toward a side of the belt.

### BACKGROUND

The invention relates generally to power-driven conveyors and more particularly to belt conveyors having actuated, belt-mounted multi-directional wheels for diverting articles conveyed by the belt.

Many package- and material-handling applications require that conveyed articles be diverted to a side of a conveyor. Two examples are sorting articles off the side of a belt and registering articles against the side of the belt. U.S. Pat. No. 6,494,312, “Modular Roller-Top Conveyor Belt with Obliquely-Arranged Rollers,” Dec. 17, 2002, to Costanzo discloses a conveyor system in which cylindrical rollers mounted in a conveyor belt on axles oblique to the direction of belt travel are actuated by underlying bearing surfaces on which the oblique rollers ride as the belt advances in the direction of belt travel. The contact between the rollers and the bearing surfaces causes the rollers to rotate as the belt advances. The rotation of the oblique rollers pushes articles atop the rollers across the conveyor belt toward a side of the conveyor. These oblique-roller belts work extremely well on planar bearing surfaces as long as the rollers are arranged to rotate at an angle between the direction of belt travel (defined as a roller angle of 0°) and about 30° or so from the direction of belt travel. For roller angles greater than 30°, the rollers slip too much on the planar bearing surfaces.

U.S. Pat. No. 6,968,941, “Apparatus and Methods for Conveying Objects,” Nov. 29, 2005, to Fourney describes an improved bearing surface that accommodates a much greater range of roller angles. Instead of using a planar bearing surface, Fourney uses the outer peripheries of actuating rollers arranged to rotate on axes in the direction of belt travel. As the conveyor belt advances, the oblique belt rollers roll on the underlying actuating rollers, which are also caused to roll on their axes. Because the bearing surface on the periphery is rolling, slip is reduced and greater roller angles can be accommodated. The greater roller angles permit much sharper article-diversion trajectories than are possible with a planar bearing surface. But actuating rollers are more expensive and slightly more complicated than simple planar bearing surfaces.

### SUMMARY

These shortcomings are addressed by a conveyor embodying features of the invention. One version of such a conveyor comprises a conveyor belt having multi-directional wheels that ride on a bearing surface. The belt has an inner side and an outer side and a pair of opposite side edges. Each of the multi-directional wheels includes a hub having a central axis of rotation and an outer periphery. Rollers are arranged on the outer periphery of the hub to rotate the rollers on axes that are transverse to the central axis of rotation of the hub. The periphery of the hub extends past the inner and outer sides of the conveyor belt. The bearing surface, which underlies the inner side of the conveyor belt, contacts the rollers on the hub's periphery that extends past the inner side of the belt to provide a surface for the rollers to ride on and cause the wheels to rotate on their central axes of rotation as the conveyor belt advances along the bearing surface.

In another aspect, a conveyor belt embodying features of the invention comprises an endless loop having an outer side and an inner side defining the thickness of the belt and a pair of opposite side edges defining the width of the belt. Multi-directional wheels are disposed at spaced apart locations along the endless loop. Each wheel includes a hub having a central axis of rotation and an outer periphery. Rollers are arranged on the periphery of the hub to rotate on roller axes transverse to the hub's central axis of rotation.

In yet another aspect, a conveyor belt module embodying features of the invention comprises a module body that extends in length from a first end to a second end, in width from a first side edge to a second side edge, and in thickness from a top side to a bottom side. Hinge elements are disposed along the first and second ends. A cavity in the module body opens onto at least one of the top side, the bottom side, the first side edge, and the second side edge. A multi-directional wheel is received in the cavity for rotation. The wheel includes a hub with a central axis of rotation and an outer periphery. Rollers are arranged on the outer periphery to rotate on roller axes transverse to the hub's central axes of rotation. The wheel rotates in the cavity about the central axis of rotation.

### BRIEF DESCRIPTION OF THE DRAWINGS

These aspects and features of the invention, as well as its advantages, are explained in more detail in the following description, appended claims, and accompanying drawings, in which:

FIG. 1 is an isometric view of a conveyor belt module embodying features of the invention including embedded multi-directional wheels;

FIG. 2 is an axonometric view of the multi-directional wheel in the conveyor belt module of FIG. 1;

FIG. 3 is a cross-sectional view of the multi-directional wheel of FIG. 2 taken along lines 3-3;

FIG. 4 is a top plan view of another version of a multi-directional wheel usable in a conveyor belt module as in FIG. 1;

FIG. 5 is a top plan view of a portion of a conveyor belt constructed of conveyor belt modules as in FIG. 1;

FIG. 6 is a front elevation view of a conveyor having a conveyor belt as in FIG. 5; and

FIG. 7A is a side view of a unidirectional roller usable in a conveyor belt as in FIG. 5, and FIG. 7B is a cross-sectional view of the unidirectional roller of FIG. 7A taken along lines 5A-5A.

### DETAILED DESCRIPTION

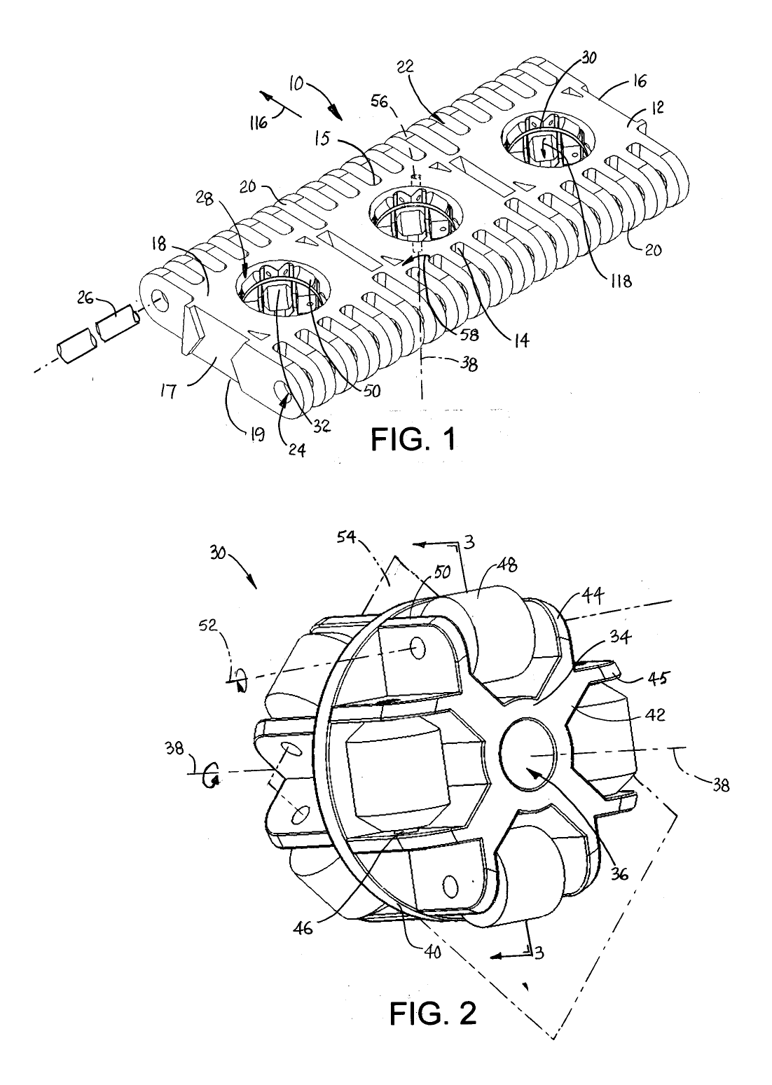

A conveyor belt module embodying features of the invention is shown in FIG. 1. The belt module 10 is made of a thermoplastic polymer in an injection-molding process. The module has a module body 12 that extends in length from a first end 14 to a second end 15, in width from a first side edge 16 to a second side edge 17, and in thickness from a top side 18 to a bottom side 19. Hinge elements 20 are spaced apart laterally by gaps 22 across the width of the module 10 along each end 14, 15 of the module body 12. Laterally aligned apertures 24 in each of the hinge elements 20 admit hinge rods 26 to connect belt modules together. Cavities 28 formed in the module body 12 open onto the top and bottom sides 18, 19 of the module. A multi-directional wheel 30 is rotatably mounted in each of the cavities. Salient portions 32 of the wheel extend past the top and bottom sides 18, 19 of the module 10.

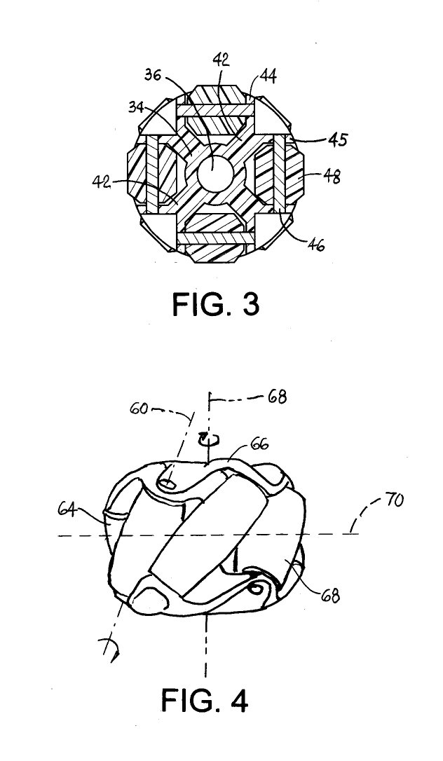

One version of a multi-directional wheel is shown in more detail in FIGS. 2 and 3. The wheel 30 includes a hub 34 surrounding a central bore 36 that defines an axis of rotation 38 of the wheel. The hub shown has a central disk portion 40 dividing the wheel into two halves. Each half has four spokes 42 extending radially outward to a forked pair of stanchions 44, 45 at distal ends of the spokes. The two stanchions of each pair are separated by an angle of 90°, as are consecutive spokes. Each stanchion supports an end of an axle 46 of a roller 48. In this version, each hub half has four rollers positioned every 90° around the outer periphery 50 of the wheel. The rollers on one hub half are offset 45° from the rollers on the other half to position the rollers more uniformly around the periphery 50 of the hub 34. The axes 52 of the axles 46 of the freely rotatable rollers 48 on the outer periphery of the hub are oriented transverse to the central axis of rotation 38 of the hub. (As used in this description, transverse axes are axes that are not parallel to each other, which includes skew axes that lie in different planes.) The axes 52 of each of the rollers 48 in each hub half lie in a plane 54 that is normal to the central axis of rotation 38. And the rollers 48 in FIG. 2 in each hub half orbit the central axis of rotation 38 in the plane containing their axes. Although this version of wheel has two sets of peripheral rollers lying in parallel planes offset from each other along the central axis of the hub, the wheel could be made with a set of peripheral rollers in a single plane or in more than two planes.

As shown in FIG. 1, the multi-directional wheel 30 is mounted in each cavity 28 on an axle 56 oblique to the side edges 16, 17 of the module body 12. This means that the wheel rotates in the direction of arrow 58 about its central axis of rotation 38. As also shown in FIG. 1, the outer periphery 50 of the wheel 30 extends past the top surface 18 of the module body 12.

Another version of a multi-directional wheel that could be rotatably mounted in the cavities 28 of the belt module 10 of FIG. 1 is shown in FIG. 4. In this version, the axes 60 of elongated crowned rollers 62 at the periphery 64 of the wheel hub 66 are also transverse to the central axis of rotation of the hub. Unlike the roller axes 52 on each hub half in FIGS. 2 and 3, which lie in a common plane, the roller axes 60 of the rollers 62 in the wheel of FIG. 4, are not coplanar. But the rollers 62 themselves orbit the central axis of rotation 68 in a plane 70 normal to the axis of rotation.

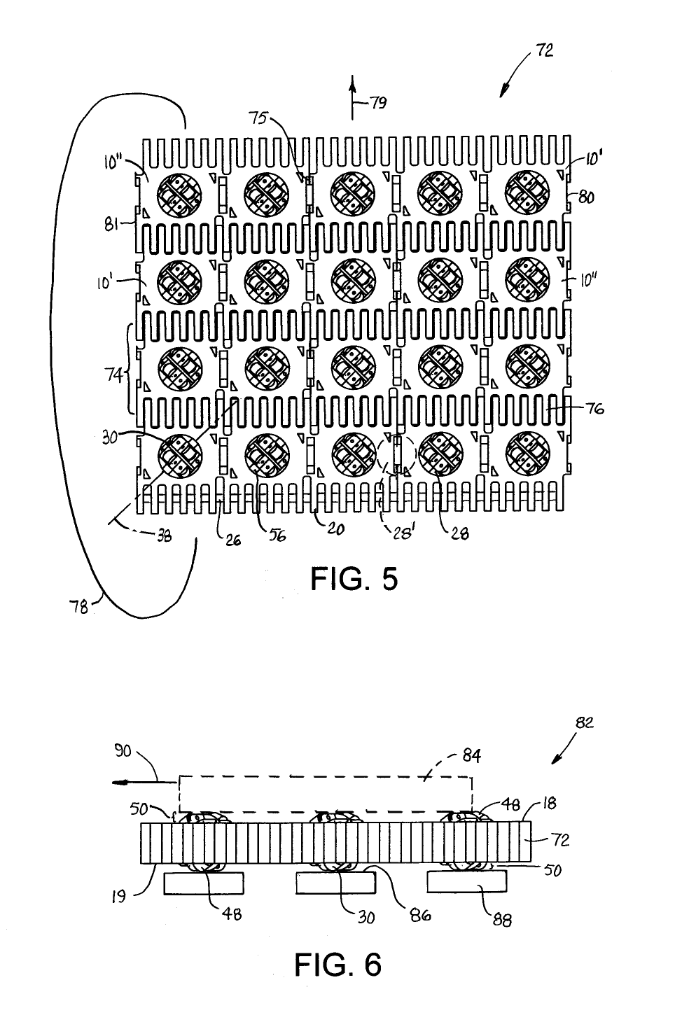

FIG. 5 shows a portion of a conveyor belt constructed of belt modules as in FIG. 1. The belt 72 is shown arranged in a bricklay pattern of wide modules 10′ and narrow modules 10″. In this example, each belt row 74 has two modules. But a belt of any width can be made by adding more modules to each belt row. A longitudinal seam 75 is formed between adjacent side-by-side modules, but is discontinuous from row-to-row in the bricklay pattern. The hinge elements 20 of consecutive belt rollers are interleaved and joined by a hinge pin 26 at a hinge joint 76. The rollers are connected end to end to form an endless belt loop 78 that is conventionally trained around drive and idle sprockets and driven in a direction of belt travel 79 along a conveying path. Each of the belt modules shown includes at least one cavity 28 in which a multi-directional wheel 30 is mounted on an axle 56 defining an axis of rotation 38 oblique to the side edges 80, 81 of the conveyor belt 72. The cavities in FIG. 5 are shown disposed between the side edges of each module. But the cavities could be formed at the seam 75 in the side edges with adjacent modules each forming a portion of the cavity 28′ and supporting an axle.

The conveyor belt 72 of FIG. 5 is shown in a conveyor embodying features of the invention in FIG. 6. The conveyor belt 72 is shown advancing on the conveyor 82 along a carryway with an article 84 supported atop the peripheries 50 of three multi-directional wheels 30. Bearing surfaces 86 underlie the conveyor belt 72 along the carryway. The bearing surfaces shown in this example are the top surfaces 86 of linear wear strips 88—one under each lane of multi-directional wheels 30. As the conveyor belt advances (into the page in FIG. 6), the wheels 30, their peripheries 50 extending past the bottom side 19 of the belt, rotate on their oblique axes as the peripheral rollers 48 rotate on the bearing surfaces 86. In this way, the bearing surfaces actuate the multi-directional wheels. The article 84 sitting atop the actuated wheels is diverted toward a side of the conveyor in the direction of arrow 90 in the direction of rotation of the wheel on its axis.

Thus, the multi-directional wheels 30 with their peripheral rollers 48 on different roller axes ride on planar bearing surfaces 86 with less slip than single-axis rollers at large oblique rotation-axis angles.

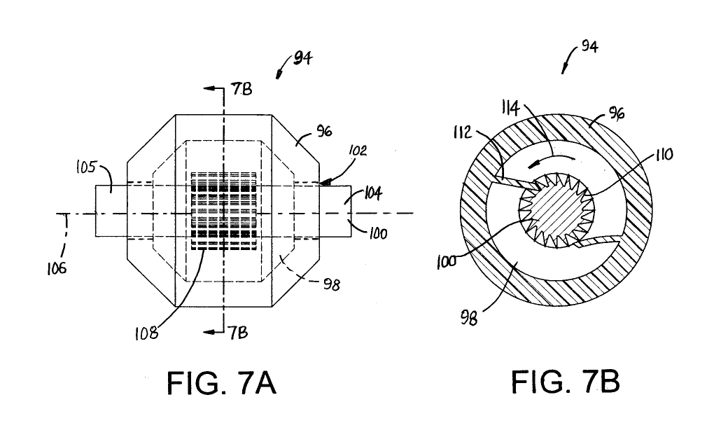

When the rollers are freely rotatable on the roller axes and able to rotate in both directions, the inertia of articles conveyed atop the wheels can cause the rollers to rotate, at least temporarily, opposite to the intended direction. In applications where even short-term reverse rotation of the rollers causes a problem, unidirectional rollers can be used instead of bidirectional rollers. As shown in FIGS. 7A and 7B, a unidirectional roller 94 has a roller body 96 surrounding an inner void 98. An axle 100 is received in a bore 102 that extends through the inner void. The ends 104, 105 of the axle are fixed in the periphery of a wheel, such as the wheel 30 of FIG. 2. The roller is free to rotate on the roller axis 106 defined by the fixed axle 100. A ratchet gear 108 having external teeth 110 is formed in the middle of the axle 100 and resides within the void 98. The roller body is made of two parts to admit the axle before the parts are joined. Structure in the form of, for example, one or more pawls 112 extending from the roller body 96 into the void 98 engages structure on the fixed axle in the form of the teeth 110 of the ratchet gear 108. The structure forming the ratchet mechanism limits the rotation of the roller 94 on its axis 106 to only one direction 114. For unidirectional roller mounted on a wheel as in FIG. 1 in a belt module used to construct a conveyor belt advancing in a direction of belt travel 116, the unidirectional roller's direction of rotation is given by arrow 118.

Although the invention has been described in detail with reference to one or two versions of conveyors, other versions are possible. For example, each row of the modular plastic conveyor belt shown in FIG. 5 need not have multi-directional wheels. Some rows of some modules could be devoid of the wheels. As another example, the conveyor belt need not be a modular plastic conveyor belt made of modules as in FIG. 1. It could be a pulley-driven or positively driven flat belt or a slat conveyor or other chain structure that can accommodate multi-directional wheels. As yet another example, the wheels described have bores receiving fixed axles around which the hub rotates. The axles could be pressed-fitted into the hub or could be stubs protruding from opposite sides of the hub whose ends are rotatably retained in the belt. The same is true of the rollers, whose axles could be rotatably retained by structure in the periphery of the hub. So, as these few examples suggest, the scope of the invention is meant to be defined by the claims and not limited to the details of the described versions.

What is claimed is:

1. A conveyor belt comprising:
an endless loop having an outer side and an inner side defining the thickness of the conveyor belt and a pair of opposite side edges defining the width of the conveyor belt;
a plurality of multi-directional wheels disposed at spaced apart locations along the endless loop, each wheel including:
a hub having a central axis of rotation and an outer periphery;
a plurality of rollers arranged on the periphery of the hub to rotate on roller axes transverse to the central axis of rotation of the hub.

2. A conveyor belt as in claim 1 wherein the conveyor belt includes a plurality of cavities opening onto at least one of the outer and inner sides of the endless loop and wherein the multi-directional wheels are mounted in the cavities with the outer peripheries of the hubs extending from the cavities past the at least one of the outer and inner sides.

3. A conveyor belt as in claim 2 wherein the cavities open onto both the outer and inner sides and wherein the outer peripheries of the hubs extend from the cavities past the inner and outer sides.

4. A conveyor belt as in claim 1 wherein the endless loop comprises a plurality of belt modules hingedly linked together in rows and wherein at least some of the rows include cavities in which the multi-directional wheels are mounted.

5. A conveyor belt as in claim 1 wherein the multi-directional wheels are mounted in the endless loop with the central axes of rotation of the hubs disposed between the inner and outer sides.

6. A conveyor belt as in claim 1 wherein the central axes of rotation of the hubs are oriented oblique to the side edges of the conveyor belt.

7. A conveyor belt as in claim 1 wherein the roller axes lie in a plane normal to the central axis of rotation of the hub.

8. A conveyor belt as in claim 1 wherein the rollers include structure to restrict rotation of the rollers on the roller axes to one direction.

9. A conveyor comprising:
a conveyor belt having an inner side and an outer side and a pair of opposite side edges and including a plurality of multi-directional wheels, each wheel including:
a hub having a central axis of rotation and an outer periphery;
a plurality of rollers arranged on the periphery of the hub to rotate on roller axes transverse to the central axis of rotation of the hub;
wherein the periphery of the hub extends past the inner and outer sides of the conveyor belt; and
a bearing surface underlying the inner side of the conveyor belt and contacting the rollers on the periphery of the hub extending past the inner side of the conveyor belt to provide a surface for the rollers to ride on and cause the wheel to rotate on the central axis of rotation of the hub as the conveyor belt advances along the bearing surface.

10. A conveyor as in claim 9 wherein the conveyor belt includes cavities opening onto both the outer and inner sides and wherein the multi-directional wheels are mounted in the cavities.

11. A conveyor as in claim 9 wherein the conveyor belt comprises a plurality of belt modules hingedly linked together in rows and wherein at least some of the rows include cavities in which the multi-directional wheels are mounted.

12. A conveyor as in claim 9 wherein the multi-directional wheels are mounted in the conveyor belt with the central axes of rotation of the hubs disposed between the inner and outer sides of the conveyor belt.

13. A conveyor as in claim 9 wherein the central axes of rotation of the hubs are oriented oblique to the side edges of the conveyor belt.

14. A conveyor as in claim 9 wherein the roller axes lie in a plane normal to the central axis of rotation of the hub.

15. A conveyor as in claim 9 wherein the rollers orbit the central axis of the hub in a plane normal to the central axis of rotation of the hub.

16. A conveyor as in claim 9 wherein the rollers include structure to restrict rotation of the rollers on the roller axes to one direction.

17. A conveyor as in claim 9 wherein the bearing surface is planar.

18. A conveyor belt module comprising:
a module body extending in a length direction from a first end to a second end, in width from a first side edge to a second side edge, and in thickness from a top side to a bottom side;
hinge elements disposed along the first and second ends;
a cavity in the module body between the first and second ends opening onto at least one of the top side, the bottom side, the first side edge, and the second side edge;
a multi-directional wheel including a hub having a central axis of rotation and an outer periphery with a plurality of rollers arranged on the periphery to rotate on roller axes transverse to the central axis of rotation of the hub;
wherein the wheel is received in the cavity for rotation about the central axis of rotation of the hub.

19. A conveyor belt module as in claim 18 wherein the cavity opens onto the top and bottom sides and wherein the outer periphery of the hub extends from the cavity past the top and bottom sides.

20. A conveyor belt module as in claim 18 wherein the multi-directional wheel is mounted in the module body with the central axis of rotation of the hub disposed between the inner and outer sides of the module body.

21. A conveyor belt module as in claim 18 wherein the central axis of rotation of the hub is oriented oblique to the first and second side edges of the module body.

22. A conveyor belt module as in claim 18 wherein the roller axes lie in a plane normal to the central axis of rotation of the hub.

23. A conveyor belt module as in claim 18 wherein the rollers include structure to restrict rotation of the rollers on the roller axes to one direction.
